(19) United States
(12) Patent Application Publication
(10) Pub. No.: US 2010/0306640 A1
(43) Pub. Date: Dec. 2, 2010

(54) SYSTEM AND METHOD FOR GENERATING FORMATTED DEVICE REPORTS FROM STORED HIERARCHICAL DEVICE DATA

(76) Inventors: Fabio M. Gava, Ladera Ranch, CA (US); Andrey Savov, Fullerton, CA (US); Manmohan Garg, Bellevue, WA (US)

Correspondence Address: SoCAL IP LAW GROUP LLP, 310 N. WESTLAKE BLVD. STE 120, WESTLAKE VILLAGE, CA, 91362, US

(21) Appl. No.: 12/474,301

(22) Filed: May 29, 2009

(51) Int. Cl. G06F 17/00; G06F 15/16

(52) U.S. Cl. 715/234; 709/206

(57) ABSTRACT

The subject application is directed to a system and method for generating formatted device reports from stored hierarchical device data. Electronic template data including a text data portion and a plurality of placeholder tags is received, wherein each placeholder tag includes data corresponding to a path in an associated, hierarchical data source corresponding to device characteristics of an associated multifunction peripheral device. Updated device data for the associated multifunction peripheral device is received into the hierarchical data source. Device data corresponding to each placeholder tag is retrieved and merged data into positions of the electronic template data in accordance with each corresponding placeholder tag so as to generate a formatted device report therefrom. A formatted device report is communicated to an associated administrator of the multifunction peripheral device.

### BACKGROUND OF THE INVENTION

The subject application is directed generally to generating reports of device status. The application is particularly applicable to generating of formatted device status reports derived from device data stored in document object model format.

Document processing devices include copiers, printers, facsimile machines, electronic mail devices, scanners, and the like. More recently, two or more of functions are being placed in one device, referred to as a multifunction peripheral (MFP) or multifunction device (MFD). Multifunction peripherals are extremely powerful business tools. Power and flexibility of these devices come at a cost of complexity. Devices must be monitored and maintained by skilled personnel, such as administrators. When enterprises have many different devices, as well as devices having different functionality or servicing requirements, there is a substantial administrative burden in tracking status of the devices. This reporting or tracking is rendered more complex when various devices employ unique or proprietary data formats. These disparate formats can make it difficult to obtain or generate reports, particularly uniformly formatted reports, that are easy to use and useful for device administrators.

### SUMMARY OF THE INVENTION

In accordance with one embodiment of the subject application, there is provided a system and method for generating formatted device reports from stored hierarchical device data. Electronic template data including a text data portion and a plurality of placeholder tags is received, wherein each placeholder tag includes data corresponding to a path in an associated hierarchical data source corresponding to device characteristics of an associated multifunction peripheral device. Updated device data for the associated multifunction peripheral device is received into the hierarchical data source. Device data corresponding to each placeholder tag is retrieved and merged data into positions of the electronic template data in accordance with each corresponding placeholder tag so as to generate a formatted device report therefrom. A formatted device report is communicated to an associated administrator of the multifunction peripheral device.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a formatted device report generation system according to one embodiment of the subject application;

FIG. 2 is a block diagram illustrating device hardware for use in the formatted device report generation system according to one embodiment of the subject application;

FIG. 3 is a functional diagram illustrating the device for use in the formatted device report generation system according to one embodiment of the subject application;

FIG. 4 is a block diagram illustrating controller hardware for use in the formatted device report generation system according to one embodiment of the subject application;

FIG. 5 is a functional diagram illustrating the controller for use in the formatted device report generation system according to one embodiment of the subject application;

FIG. 6 is a block diagram illustrating the formatted device report generation system according to one embodiment of the subject application;

FIG. 7 is a functional diagram illustrating the formatted device report generation system according to one embodiment of the subject application;

FIG. 8 is a flowchart illustrating a method for generating formatted device reports according to one embodiment of the subject application; and

FIG. 9 is a flowchart illustrating a method for generating formatted device reports according to one embodiment of the subject application.

### DETAILED DESCRIPTION OF THE PREFERRED EMBODIMENT

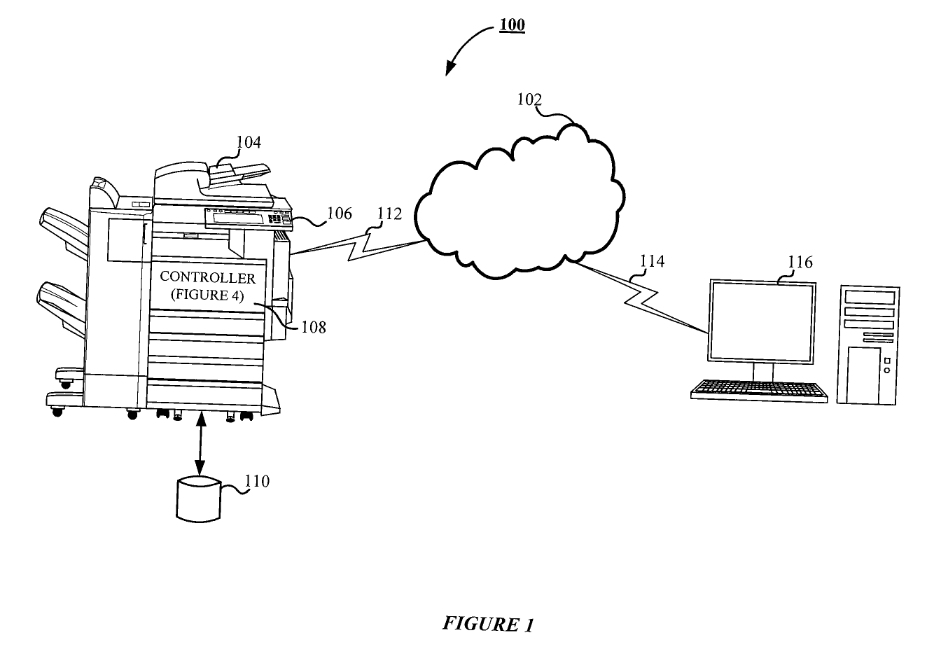

The subject application is directed to a system and method for generating formatted device reports. In particular, the subject application is directed to a system and method for generating formatted device reports from stored hierarchical device data. It will become apparent to those skilled in the art that the system and method described herein are suitably adapted to a plurality of varying electronic fields employing device report generation including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for generating formatted device reports in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, which is depicted in FIG. 1 as a multifunction peripheral device suitably adapted to perform a variety of document rendering or processing operations. It will be appreciated by those skilled in the art that such document rendering operations include, for example and without limitation, facsimile, scanning, copying, printing, electronic mail, document management, document storage, or the like. Suitable commercially-available document processing devices include, for example and without limitation, the Toshiba e-Studio Series Controller. In accordance with one aspect of the subject application, the document processing device 104 is suitably adapted to provide remote document rendering or processing services to external or network devices. Preferably, the document processing device 104 includes hardware, software, or any suitable combination thereof configured to interact with an associated user, a networked device, or the like.

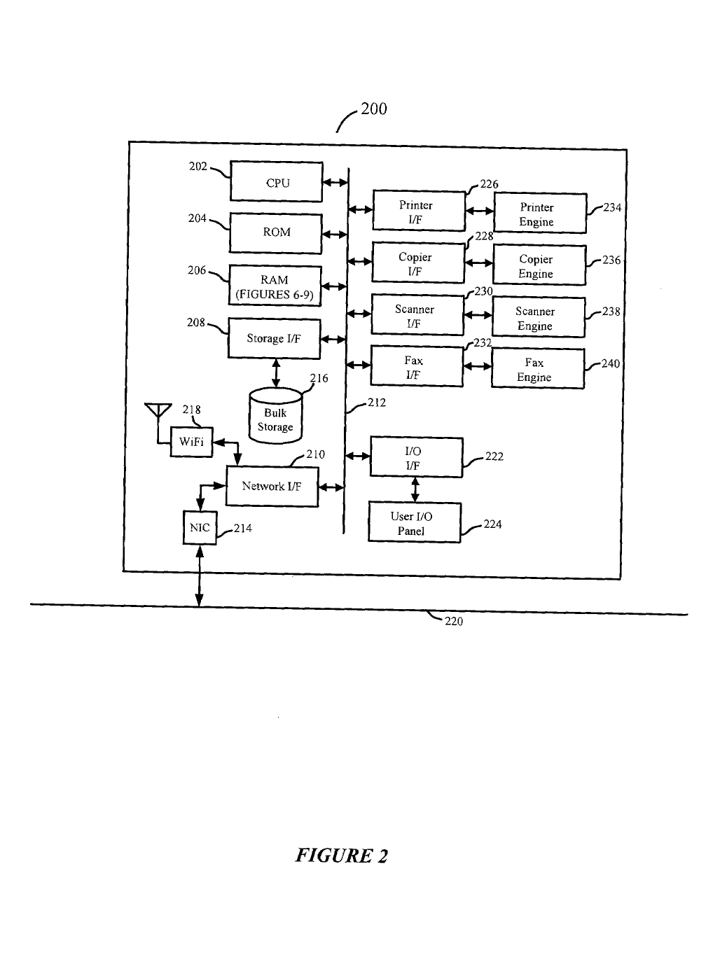

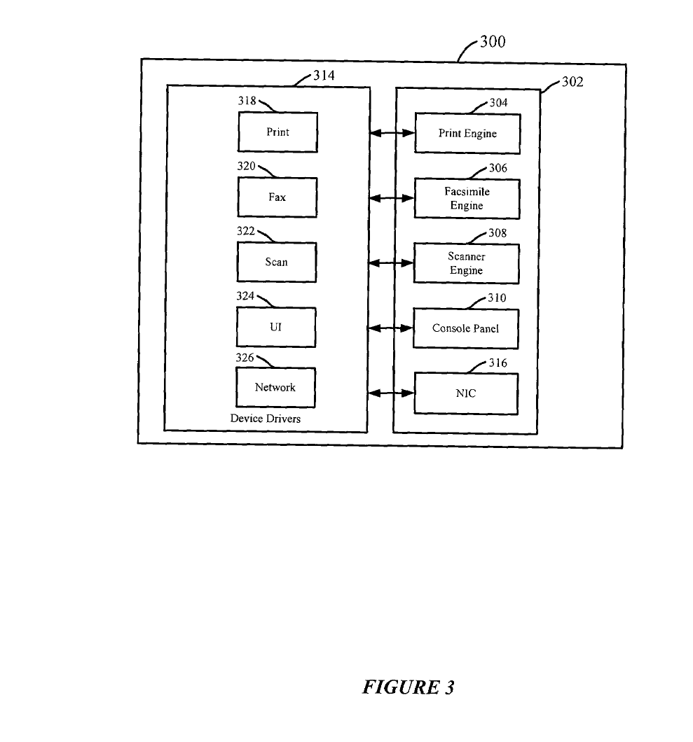

According to one embodiment of the subject application, the document processing device 104 is suitably equipped to receive a plurality of portable storage media including, without limitation, Firewire drive, USB drive, SD, MMC, XD, compact flash, memory stick, and the like. In the preferred embodiment of the subject application, the document processing device 104 further includes an associated user interface 106 such as a touch screen, LCD display, touch-panel, alpha-numeric keypad, or the like via which an associated user is able to interact directly with the document processing device 104. In accordance with the preferred embodiment of the subject application, the user interface 106 is advantageously used to communicate information to the associated user and to receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user; to receive input from the associated user; and to communicate the same to a backend component such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

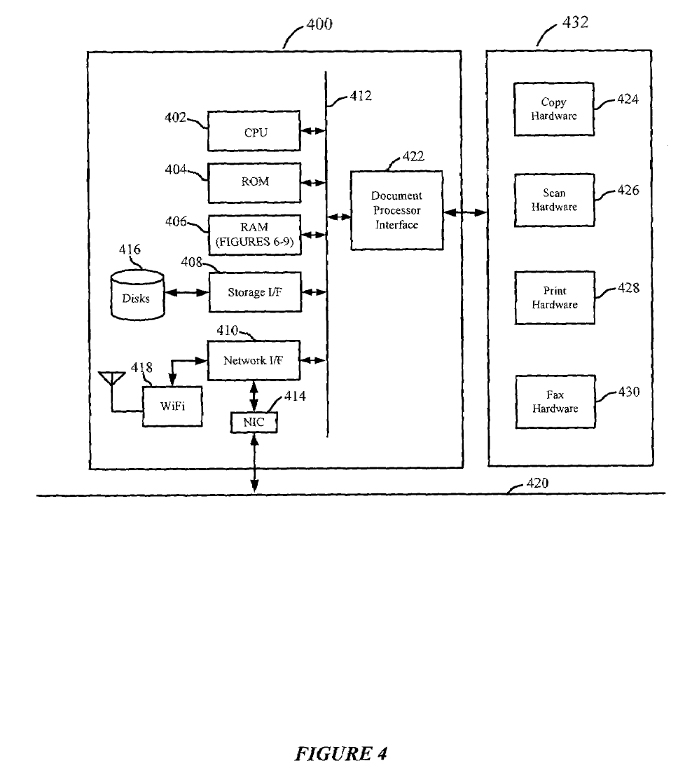

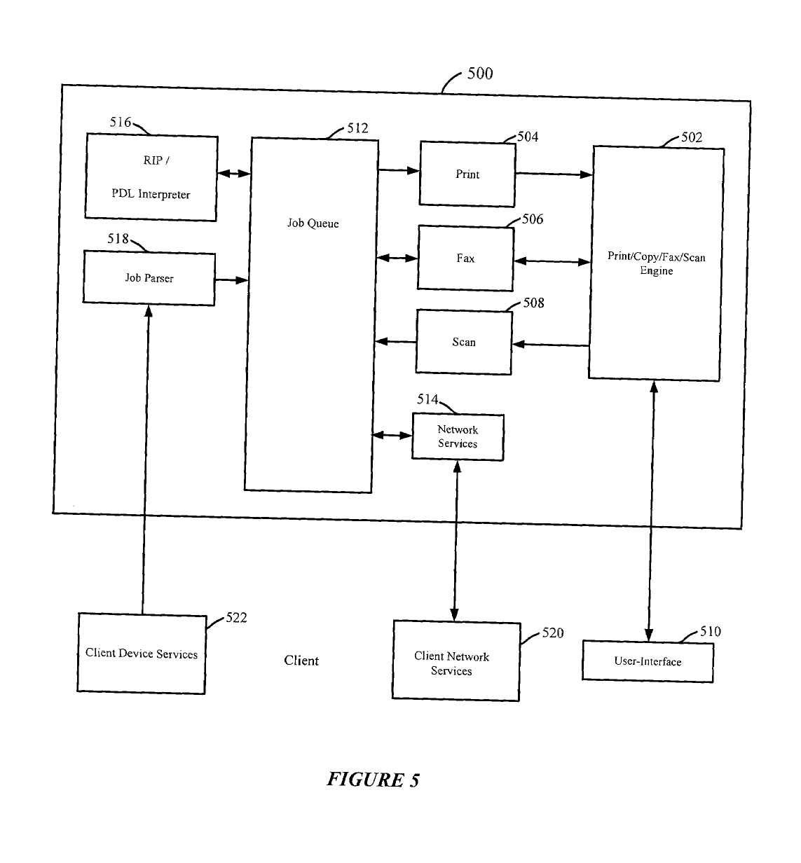

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, to facilitate the display of images via the user interface 106, to direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments that will be apparent to one skilled in the art are capable of employing the system and method for generating formatted device reports. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

Depicted in FIG. 1 is an administrative device 116, illustrated as a computer workstation in data communication with the computer network 102 via a communications link 114. It will be appreciated by those skilled in the art that the administrative device 116 is shown in FIG. 1 as a computer workstation for illustration purposes only. As will be understood by those skilled in the art, the administrative device 116 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 114 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. According to one embodiment of the subject application, the administrative device 116 further includes a suitable accounting system configured to monitor, track, and bill operations of the associated document processing device 104. According to one embodiment of the subject application, the administrative device 116 is capable of receiving and analyzing device status reports received from the multi-function peripheral device or other suitable devices as will be understood by one skilled in the art. In accordance with a further embodiment of the subject application, the administrative device 116 is capable of providing document data, user interface data, and/or image data; monitoring document processing jobs, user accounts, and/or billing information; employing thin-client interfaces; generating display data or output data; or the like with respect to the document processing device 104 or any other similar device coupled to the computer network 102.

Turning now to FIG. 2, illustrated is a representative architecture of a suitable device 200, shown in FIG. 1 as the document processing device 104, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing device 104, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302 that facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316 with a network via driver 326 suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser 518 suitably functions to receive print job language files from an external device such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

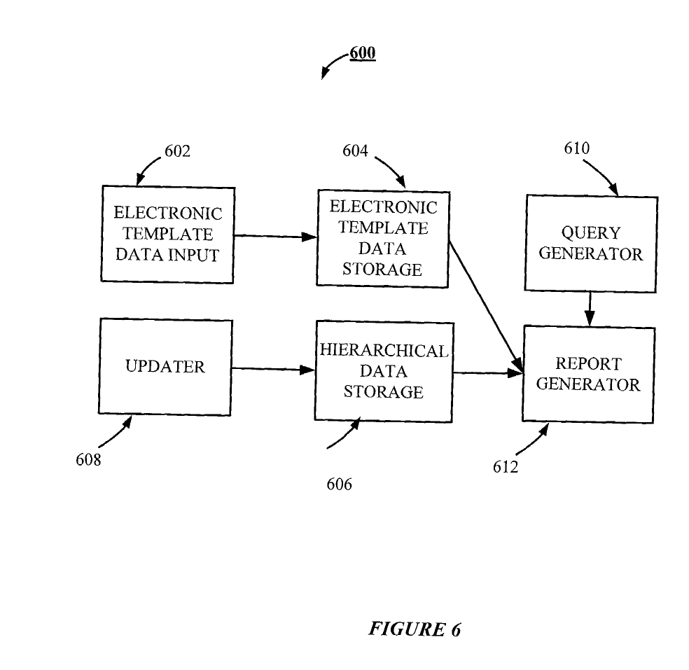

Turning now to FIG. 6, illustrated is a block diagram of a system 600 for generating formatted device reports in accordance with one embodiment of the subject application. The system 600 includes an electronic template data input 602 configured to receive electronic template data. The electronic template data includes a text data portion and a plurality of placeholder tags. Each placeholder tag includes data corresponding to a path in associated, hierarchical data source corresponding to device characteristics of an associated multifunction peripheral device. The system 600 further includes an electronic template data storage 604. Preferably, the electronic template data storage 604 is in electronic communication with the electronic template data input 602. The system 600 also includes a hierarchical data storage 606 associated with a multifunction peripheral device. The hierarchical data storage 606 stores device data corresponding to a plurality of device characteristics. An updater 608 routes updated device data of the associated multifunction peripheral device corresponding to changed conditions of the multifunction peripheral device to the hierarchical data storage 606. The system 600 further includes a query generator 610 configured to generate a query for a formatted device report. In response to an output from the query generator 610, a report generator 612 generates a formatted device report relative to a status of the multifunction peripheral device. The formatted report includes the text data and updated device data positioned in accordance with the placeholder tags. Preferably, the report generator 612 is in electronic communication with the electronic template data storage 604 and the hierarchical data storage 606.

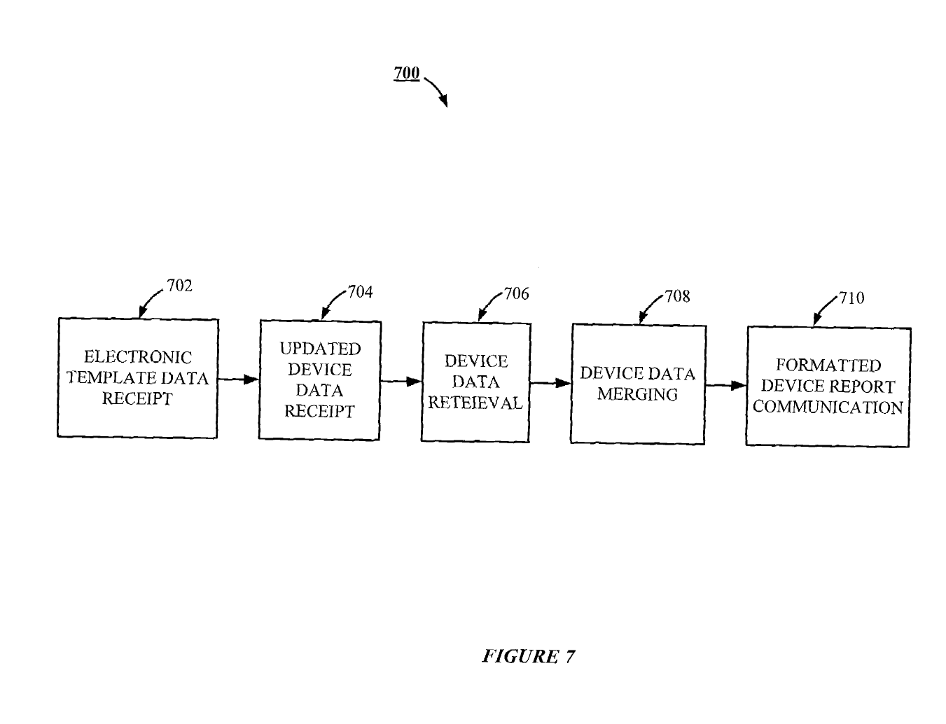

Referring now to FIG. 7, there is shown a functional diagram 700 illustrating the formatted device report generation system in accordance with one example embodiment of the subject application. As shown in FIG. 7, electronic template data receipt 702 occurs first. Preferably, the template data includes a text data portion and a plurality of placeholder tags. In addition, each placeholder tag preferably includes data corresponding to a path in an associated, hierarchical data source corresponding to device characteristics of an associated multifunction peripheral device.

Updated device data receipt 704 then occurs for the associated multifunction peripheral device. Preferably, the data is received by the hierarchical data source. Device data corresponding to each placeholder tag is then retrieved at 706 from the hierarchical data source and merged at 708 into positions of the electronic template data in accordance with each corresponding placeholder tag so as to generate a formatted device report therefrom. Formatted device report communication 710 then occurs. According to one example embodiment of the subject application, for example and without limitation, a formatted device report is communicated to an associated administrator of the multifunction peripheral device.

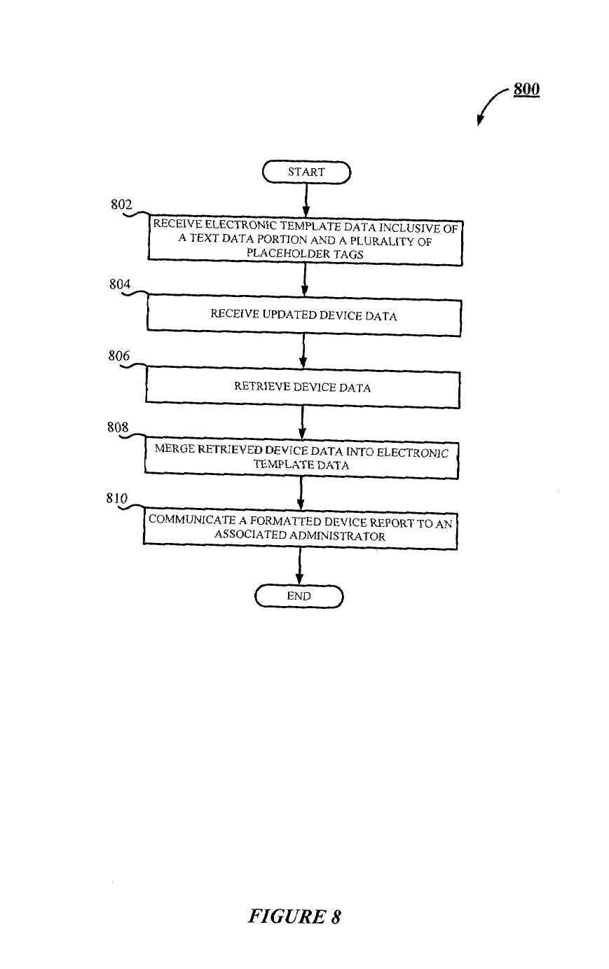

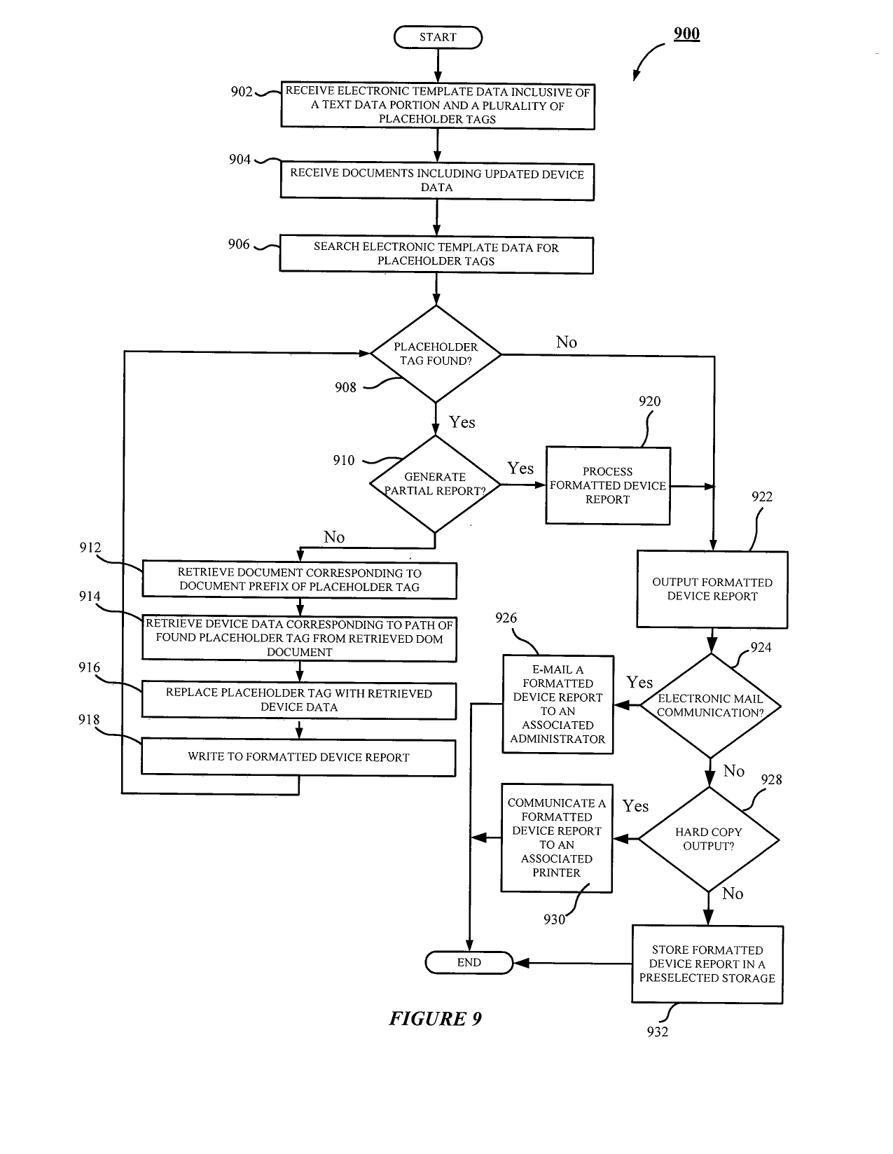

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a method for generating formatted device reports in accordance with one embodiment of the subject application. Beginning at step 802, electronic template data including a text data portion and a plurality of placeholder tags is received. Each placeholder tag includes data corresponding to a path in an associated, hierarchical data source corresponding to device characteristics of an associated multifunction peripheral device.

At step 804, updated device data is received for the associated multifunction peripheral device into the hierarchical data source. In one example embodiment of the present application, updated device data is represented in a Document Object Model hierarchical format. At step 806, device data corresponding to each placeholder tag is retrieved from the hierarchical data source. At step 808, the retrieved device data is merged into positions of the electronic template data in accordance with each corresponding place holder tag so as to generate a formatted device report. At step 810, the formatted device report is communicated to an associated administrator of the multifunction peripheral device.

Referring now to FIG. 9, there is shown a flowchart 900 illustrating a method for generating formatted device reports in accordance with one embodiment of the subject application. The methodology of FIG. 9 begins at step 902, whereupon electronic template data including a text data portion and a plurality of placeholder tags is received. In one example embodiment of the present application, each placeholder tag includes data corresponding to a path in an associated, hierarchical data source corresponding to device characteristics of an associated multifunction peripheral device. At step 904, documents including updated device data are received for the associated multifunction peripheral device into the hierarchical data source. At step 906, the controller 108 or other suitable component associated with the document processing device 104 searches the electronic template data for placeholder tags.

At step 908, a determination is made whether a placeholder tag is found. When it is determined that a placeholder tag is found, flow proceeds to step 910. It will be appreciate by those skilled in the art that the placeholder tag may include various suitable forms. In one example embodiment of the present application, the placeholder tag is a container tag which is replaced in the formatted device report by the content of the path in the referenced hierarchical data source. In another example, the placeholder tag is an indirect container tag where the path in the referenced hierarchical data source contains a path to the data rather then containing the data itself. In another example, the placeholder tag is a dynamic content tag which is replaced with report metadata. Report metadata may include, but is not limited to, total pages in the report, number of data records in the report, records per page, etc. In another example, the placeholder tag is a formatting tag which provides information on how to format the contents of the path in the referenced hierarchical data source. In another example, the placeholder tag is an image tag which is replaced in the formatted device report by an image. The image tag indicates the path in the referenced hierarchical data source that contains the image file path and whether an encoding is to be applied to the image. In yet another example, the placeholder tag is a record tag which is replaced in the formatted device report by one record in the referenced hierarchical data source. A record tag is enclosed within a dynamic content tag. As a result, multiple records may be inserted into the formatted device report.

Returning now to FIG. 9, at step 910, a determination is made whether to generate a partial report in which case a formatted device report would contain placeholder tags to be replaced in a future pass. When it is determined not to generate a partial report, flow proceeds to step 912. At step 912, the document corresponding to a document prefix of the placeholder tag is retrieved from the hierarchical data source. At step 914, device data corresponding to a path of the placeholder tag is retrieved from the document. At step 916, the placeholder tag is replaced with the retrieved device data. At step 918, after the placeholder tag is replaced with device data, the device data is written to the formatted device report. Flow then returns to step 908 whereupon a determination is made whether additional tags are found. When additional tags remain, flow proceeds to step 910 where a determination is made whether or not to generate a partial report. Upon determining to generate a partial report, operation proceeds to step 920 where the formatted device report is first processed. Inserted device data matching the syntax of a replacement tag is marked in the formatted device report. For example, the syntax “###” may represent a replacement tag. Thus, inserted device data matching such syntax may be marked with a “\.” In the formatted device report, the inserted device data would appear as “\###” while a replacement tag would appear as “###.” This prevents the inserted device data from being interpreted as a replacement tag in future passes. During a final pass, the marks are removed to reflect proper data in the formatted device report.

Upon determining at step 908 that a placeholder tag was not found or after processing the formatted device report upon determining at step 910 to generate a partial report, operations progress to step 922 where the formatted device report is output. If a determination is then made at 924 to communicate the formatted device report via electronic email, the report is emailed to an associated administrator at 926. If a determination is made at 924 not to communicate the formatted device report via electronic mail but a determination is made at 928 to output the report in hard copy form, the formatted device report is communicated to an associated printer at 930. If it is determined at 928 not to output a hard copy of the formatted device report, the report is stored in a preselected storage at 932.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for generating formatted device reports from stored hierarchical device data comprising:
an input for electronic template data including a text data portion and a plurality of placeholder tags, each placeholder tag including data corresponding to a path in an associated, hierarchical data source corresponding to device characteristics of an associated multifunction peripheral device;
a data storage operable for storage of electronic template data inclusive of text data and a plurality of placeholder tags;
a hierarchical data storage associated with a multifunction peripheral device in which is stored device data corresponding to a plurality of device characteristics thereof;
an updater operable to route updated device data of the associated multifunction peripheral device corresponding to changed conditions of the multifunction peripheral device to the hierarchical data storage;
a query generator operable to generate a query for a formatted device report; and
a report generator, responsive to the query generator, operable to generate a formatted device report relative to a status of the multifunction peripheral device, the formatted report including the text data and updated device data positioned in accordance with the placeholder tags.

2. The system of claim 1 further comprising an electronic mail system operable to electronic mail the formatted device report to at least one recipient.

3. The system of claim 1 further comprising an elapsed time measurement system and wherein the updater is operable in accordance with an output thereof.

4. The system of claim 1 wherein the report generator is further operable to generate the formatted device report as an electronic spreadsheet.

5. The system of claim 1 wherein the device data is comprised of a document object model.

6. A method of generating formatted device reports from stored hierarchal device data comprising the steps of:
receiving electronic template data including a text data portion and a plurality of placeholder tags, each placeholder tag including data corresponding to a path in an associated, hierarchical data source corresponding to device characteristics of an associated multifunction peripheral device;
receiving updated device data for the associated multifunction peripheral device into the hierarchical data source;
retrieving, from the hierarchical data source, device data corresponding to each placeholder tag;
merging retrieved device data into positions of the electronic template data in accordance with each corresponding placeholder tag so as to generate a formatted device report therefrom; and
communicating a formatted device report to an associated administrator of the multifunction peripheral device.

7. The method of claim 6 further wherein step of retrieving includes the step of retrieving the device data in accordance with path data relative to the hierarchical data source, which path data forms at least a portion of each corresponding placeholder tag.

8. The method of claim 7 wherein the step of retrieving includes the step of retrieving the device data with path data corresponding to a document object model representation forming the hierarchical data source.

9. The method of claim 8 wherein the step of communicating includes the step of communicating the formatted report to an associated printer to generate a hard copy output therefrom.

10. The method of claim 8 wherein the step of communicating includes the step of communicating the formatted report via electronic mail.

11. A system of generating formatted device reports from stored hierarchal device data comprising:
means adapted for receiving electronic template data including a text data portion and a plurality of placeholder tags, each placeholder tag including data corresponding to a path in an associated, hierarchical data source corresponding to device characteristics of an associated multifunction peripheral device;
means adapted for receiving updated device data for the associated multifunction peripheral device into the hierarchical data source;
means adapted for retrieving, from the hierarchical data source, device data corresponding to each placeholder tag;
means adapted for merging retrieved device data into positions of the electronic template data in accordance with each corresponding placeholder tag so as to generate a formatted device report therefrom; and
means adapted for communicating a formatted device report to an associated administrator of the multifunction peripheral device.

12. The system of claim 11 further wherein the means adapted for retrieving include means adapted for retrieving the device data in accordance with path data relative to the hierarchical data source, which path data forms at least a portion of each corresponding placeholder tag.

13. The system of claim 11 wherein the means adapted for retrieving include means adapted for retrieving the device data with path data corresponding to a document object model representation forming the hierarchical data source.

14. The system of claim 13 wherein the means adapted for communicating include means adapted for communicating the formatted report to an associated printer to generate a hard copy output therefrom.

15. The system of claim 13 wherein the means adapted for communicating include means adapted for communicating the formatted report via electronic mail.
